(19) United States
(12) Patent Application Publication
(10) Pub. No.: US 2021/0327119 A1
(43) Pub. Date: Oct. 21, 2021

(54) System for Generating a Three-Dimensional Scene Reconstructions

(71) Applicant: Occipital, Inc., Boulder, CO (US)

(72) Inventors: Ivan Malin, Moscow (RU); Oleg Kazmin, Moscow Region (RU); Anton Yakubenko, Boulder, CO (US); Gleb Krivovyaz, Moscow (RU); Yury Berdnikov, Moscow (RU); George Evmenov, Moscow (RU); Timur Ibadov, Odintsovo (RU); Yuping Lin, San Jose, CA (US); Jeffrey Roger Powers, San Francisco, CA (US); Vikas Muppidi Reddy, Boulder, CO (US)

(21) Appl. No.: 17/301,833

(22) Filed: Apr. 15, 2021

Related U.S. Application Data
(60) Provisional application No. 63/011,409, filed on Apr. 17, 2020.

(51) Int. Cl. G06T 15/06; G06T 17/20; G06T 7/55

(52) U.S. Cl. CPC G06T 15/06; G06T 7/55; G06T 17/20

(57) ABSTRACT

A system configured to generate a three-dimensional scene reconstruction of a physical environment. In some cases, the system may store the three-dimensional scene reconstruction as two or more meshes and/or as one or more ray bundles including a plurality of depth values from a center point of the bundle.

### CROSS-REFERENCE TO RELATED APPLICATION(S)

This application claims priority to U.S. Provisional Application No. 63/011,409 filed on Apr. 17, 2020 and entitled “System and Application for Capture and Generation of Three-Dimensional Scene,” which is incorporated herein by reference in their entirety.

### BACKGROUND

The presence of three dimensional (3D) imaging and virtual reality systems is becoming more and more common. In some cases, the imaging system or virtual reality system may be configured to allow a user to interact with a three-dimensional virtual scene of a physical environmental. In some case, the users may capture, or scan image data associated with the physical environment and the system may generate the three-dimensional virtual scene reconstruction. However, conventional single mesh-based reconstructions can produce gaps, inconsistencies, and occlusions visible to a user when viewing with the reconstructed scene.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example of a user scanning a physical environment with a capture device and associated cloud-based service according to some implementations.

FIG. 2 is an example flow diagram showing an illustrative process for generating a three-dimensional scene reconstruction of a physical environment according to some implementations.

FIG. 3 is another example flow diagram showing an illustrative process for generating a three-dimensional scene reconstruction of a physical environment according to some implementations.

FIG. 4 is another example flow diagram showing an illustrative process for generating a plane of a three-dimensional scene reconstruction according to some implementations.

FIG. 5 is another example flow diagram showing an illustrative process for generating a three-dimensional scene reconstruction of a physical environment according to some implementations.

FIG. 6 is another example flow diagram showing an illustrative process for generating a three-dimensional scene reconstruction of a physical environment according to some implementations.

FIG. 7 is another example flow diagram showing an illustrative process for generating a three-dimensional scene reconstruction of a physical environment according to some implementations.

FIG. 8 is another example flow diagram showing an illustrative process for generating a three-dimensional scene reconstruction of a physical environment according to some implementations.

FIG. 9 is another example flow diagram showing an illustrative process for presenting a three-dimensional scene reconstruction of a physical environment according to some implementations.

FIG. 10 is another example flow diagram showing an illustrative process for generating a three-dimensional scene reconstruction of a physical environment according to some implementations.

FIG. 11 is an example device associated with the three-dimensional scene reconstruction according to some implementations.

FIG. 12 is an example pictorial diagram illustrating the process of FIG. 10 according to some implementations.

### DETAILED DESCRIPTION

This disclosure includes techniques and implementations for generating and storing three-dimensional scene reconstructions in a time and resource efficient manner. In some examples, the system may generate reconstructions represented by and stored as one or more ray bundles. In some cases, each ray bundle may be associated with a center point and include a ray or value at each degree (or other interval) to generate rays extending from the center point in a spherical degree manner. Each ray or value may represent a depth between the center point and a first intersected plane or object. In some cases, the system may store multiple or an array of rays or values that represent depth associated with a second, third, fourth, etc. plane or object intersected by the ray at each degree.

In some examples, the system may utilize multiple center points for multiple ray bundles, such that each ray bundle includes a plurality of rays or values representing depth between the center point and nearby planes or objects. In these examples, each ray bundle may be used to generate a reconstruction. The system may then combine each of the reconstructions into a single model or scene. In some cases, the system may generate the three-dimensional scene reconstructions using the ray bundles as well as various other data known about the physical environment, such as a point cloud generated by a simultaneous localization and mapping (SLAM) tracking operation hosted on the capture device, various normals associated with detected planes and lines, differentials in color variation between pixels or points and/or frames, known constraints (e.g., vertical, horizontal, Manhattan, perpendicular, parallel, and the like), and the like.

For example, in one implementation, the system may receive image data representative of a physical environment. For instance, the image data may include a plurality of frames, video data, red-green-blue data, infrared data, depth data, and the like. The system may then select a point, such as a capture point or average capture point associated with the image data. The system may then align the frames of the image data in a spherical manner about or around the selected point. The point may then be projected into each of the frames at various degrees. For each intersection with a frame, the system may determine a color consistency or variance with respect to nearby pixels at various depths. The system may then rank the frames and select the depth and/or frame having the best color consistency or variance (e.g., the smallest differences in color values may have the highest rank) for use in scene reconstruction. In other implementations, the system may use a photo-consistency (e.g., for a larger area such as between portions of the frame) in lieu of or in addition to the color consistency or variance between pixels. In still other examples, the system may utilize smoothness, texture variance, and the like to rank the frames and determine a depth for the ray.

The system may also estimate normals for various points or pixels within the selected image data or frame, for instance, via one or more machine learned models. The system may then use the estimated normals to segment the image data into objects, planes, or surfaces and assign a depth value to the corresponding ray. In other examples, the system may determine portions of the image data or frame that may represent planes and use that corresponding image data to determine normals for the planes. The system may then assign a depth based on a point cloud generated by a SLAM tracking operation hosted on the capture device.

In some implementations, the system may also detect ceiling and floor planes separate from other object planes or walls. The system may then planarize the pixels associated with the ceiling and floors, as the ceiling and floors should be substantially flat or horizontal. In other examples, the system may generate a stitched or temporary panorama reconstruction about the center point. The system may utilize the stitched panorama to estimate initial planes and normals using an approximate depth, such as determined using the color variance, photogrammetry, and/or regularization. The initial planes and normals may then be an input to one or more machine learned models which may classify, segment, or otherwise output a more accurate panorama, reconstruction, normals, objects, planes, or other segmented portions of the image data.

The system may also refine or otherwise optimize the depth values for the rays using various techniques. For example, the system may apply a smoothness constraint to disallow depth discontinuities over pixels within a defined smooth or continuous region to less than or equal to a depth threshold. The system may also apply constraints or threshold limitations to variance between the surface normals within a defined smooth or continuous region. The system may also apply planarity or depth constraints or thresholds to regions defined as planes. The system may also apply one or more point constraints, line constraints, region construction and the like based on photogrammetry, deep learning or machine learned models, or external sensors data (such as depth data, gravity vectors, and the like).

As one specific example, the system may segment two surfaces or objects based on the depth assigned to each of the rays. However, in some cases, such as a face or other non-planar object the segmentation may be noisy or otherwise misaligned. In these examples, the system may adjust the segmentation between the planes or objects by identifying the largest depth discontinuity within a defined region. In this manner, the system may more accurately and cleanly define the boundary between segmented planes or objects. In other cases, the system may detect the largest gradient within a neighborhood or region and define the boundary between the segmented planes or objects at the largest gradient.

In some implementations, the scene reconstruction may be represented as multiple meshes, such as a background and a foreground mesh. In some instances, the system may assign a surface, object, plane or the like to the foreground or background using the depth data associated with each ray of the ray bundle. For example, when a depth discontinuity (e.g., a change in depth greater than or equal to a threshold) is encountered, the system may assign the surface, object, plane or the like with the larger depth value (e.g., further away from the center point) to the background mesh. The system may then fill holes with regards to each mesh independently to improve the overall visual quality and reduce visual artifacts that may be introduced with a single mesh reconstruction.

In some cases, the system may encounter various surfaces, such as mirrors, windows, or other reflective or transport surfaces, that may present difficulty during reconstruction. In these instances, the system may detect lines representative of a window, mirror, or the like within a plane as well as the presence of similar image data at another location within the scene. In the cases, that one or both conditions are true, the system may remove the geometry within the mirror, window, or reflective surface prior to performing scene reconstruction operations.

In some cases, the reconstruction may still include one or more holes. In these cases, the system may limit movement within the scene or reconstruction to a predetermined distance from the center point of the ray bundle. In other cases, the system may display a warning or alert that the user has moved or exceeded the predetermined distance and that the scene quality may be reduced. In some cases, the system may prompt the user to capture additional image data at a new capture point to improve the quality of the reconstructed scene. In some cases, holes within the background mesh may be filled with a pixel having the same (or an averaged) normal and color as the adjacent pixels.

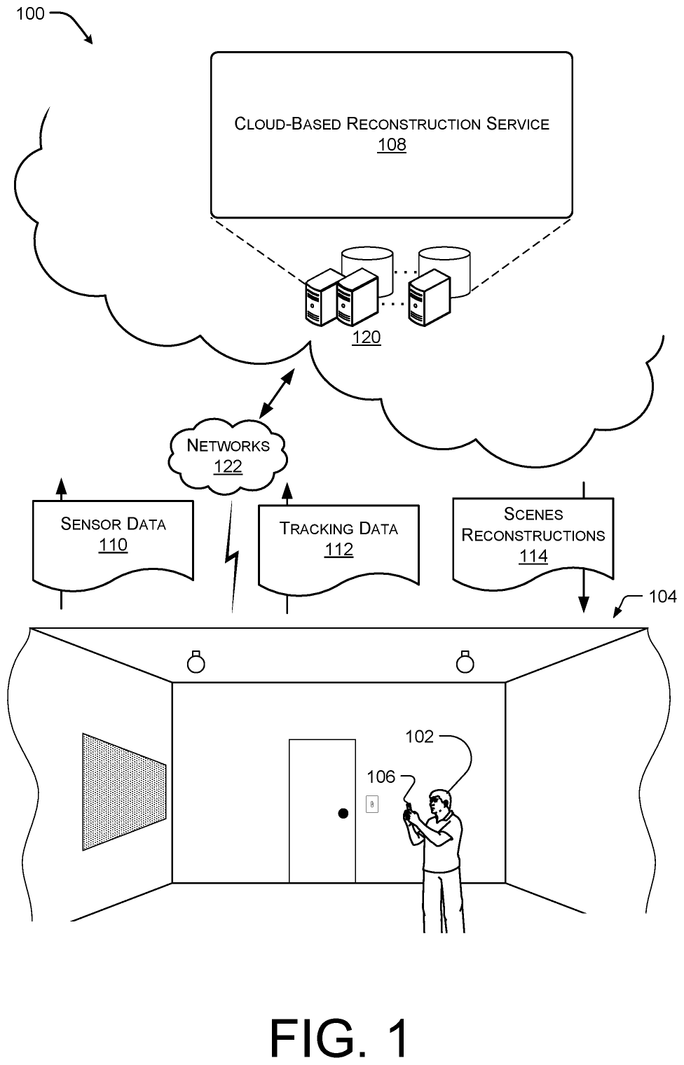

FIG. 1 illustrates an example of a user 102 scanning a physical environment 104 with a capture device 106 and associated cloud-based service 110 according to some implementations. In the current example, the user 102 may select a position relatively nearby the center of the physical environment 104. The user 102 may then initialize a three-dimensional scanning or modeling application hosted on the capture device 106 to generate image and/or sensor data 110 associated with the physical environment 104 in order to generate a three-dimensional scene reconstruction.

In some cases, the capture device 106 may provide the user 102 with instructions via an output interface, such as a display. The instructions may cause the user to perform a capture of the physical environment to generate the sensor data 110. For example, the user 106 may be instructed to capture the sensor data 110 in a spherical view or panorama of the physical environment 104. In some cases, the capture device 106 may also implement SLAM tracking operations to generate tracking data 112 (e.g., key points or a point cloud having position data and associated with the sensor data 110).

In this example, either a scene reconstruction module hosted on the capture device 106 and/or the cloud-based reconstruction service 108 may be configured to generate a three-dimensional scene reconstruction 114 representative of the physical environment 104. For example, in some implementations, the processes, such as the scanning, segmentation, classification (e.g., assigning semantic labels), reconstruction of the scene, and the like, may be performed on capture device 106, in part on the capture device 106 and in part using cloud-based reconstruction services 108, and/or the processing may be substantially (e.g., other than capturing sensor data) performed at the cloud-based reconstruction services 108. In one implementation, the application hosted on the capture device 106 may detect the capabilities (e.g., memory, speed, through-put, and the like) of the capture device 106 and, based on the capabilities, determine if the processing is on-device, in-the-cloud or both. When the cloud-based services are used, the capture device 106 may upload the sensor data 110 in chunks or as a streamed process. In one specific example, the capture device 106 may run real-time tracker and SLAM operations on the capture device 106 to provide the user with real-time tracking data 112 usable to improve the quality of the three-dimensional scene reconstruction 114.

In some cases, the three-dimensional scene reconstruction 114 may be a model, panorama with depth, or other virtual environment traversable via a three-dimensional viewing system or viewable on an electronic device with a display (such as the capture device 106). In some implementations, the three-dimensional scene reconstruction 114 may include one or more ray bundles. Each ray bundle may be associated with a center point and include one or more rays or values at each degree (or other predetermined interval). The rays, generally, extend from the center point over each degrees about a sphere, for instance, at a specified resolution. Each ray or value represents a depth or depth value between the center point and a first intersected plane, surface, or object within the physical environment 104. In some cases, each ray bundle may have at each degree or interval multiple rays or values that represent depth associated with a second, third, fourth, etc. plane, surface, or object intersected by the ray at each degree. For example, each subsequent ray or value may represent the distance or depth between the end point of the first ray and a subsequent intersection with a plane, surface, or object.

In some examples, the three-dimensional scene reconstruction 114 may include multiple center points for multiple ray bundles, such that each ray bundle includes a plurality of rays or values representing depth between the center point and nearby planes, surfaces, or objects. In this manner, the use of multiple ray bundles allows for the user 102 to traverse the three-dimensional scene reconstruction 114 and/or to otherwise view the three-dimensional scene reconstruction 114 from multiple vantage points or viewpoints. In some cases, the user 102 may also be able to view the three-dimensional scene reconstruction 114 from positions between the center point of different ray bundles.

In some examples, either a scene reconstruction module hosted on the capture device 106 and/or the cloud-based reconstruction service 108 may combine multiple scene reconstructions (such as a reconstruction for each ray bundle) into a single model or scene reconstruction 114. In some cases, the scene reconstruction module and/or the cloud-based reconstruction service 108 may generate the three-dimensional scene reconstructions 114 using the ray bundles in conjunction with various other data known about the physical environment 104, such as the tracking data 112, differentials in color variation between pixels, patches, within or between frames, known constraints (e.g., vertical, horizontal, Manhattan, perpendicular, parallel, and the like), and the like.

As discussed above, in one example, the capture device 106 may be a portable electric device, such as a tablet, netbook, laptop, cell phone, mobile phone, smart phone, etc. that includes processing and storage resources, such as processors, memory devices, and/or storage devices. The cloud-based services 108 may include various processing resources, such as the servers and datastores, generally indicated by 120, that are in communication with the capture device 106 and/or each other via one or more networks 122.

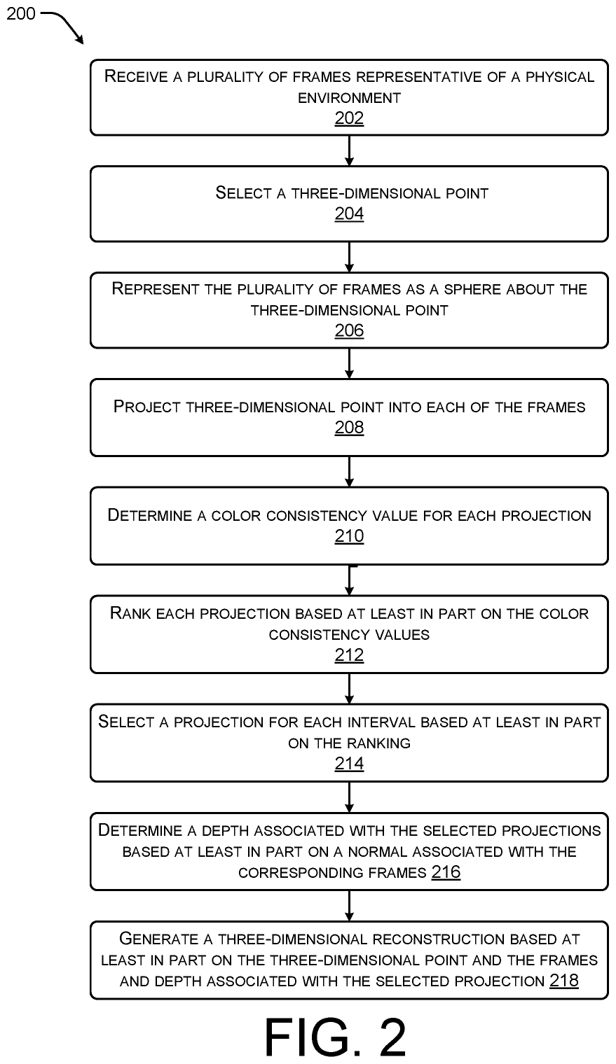

FIGS. 2-10 are flow diagrams illustrating example processes associated with generating a three-dimensional scene reconstruction according to some implementations. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

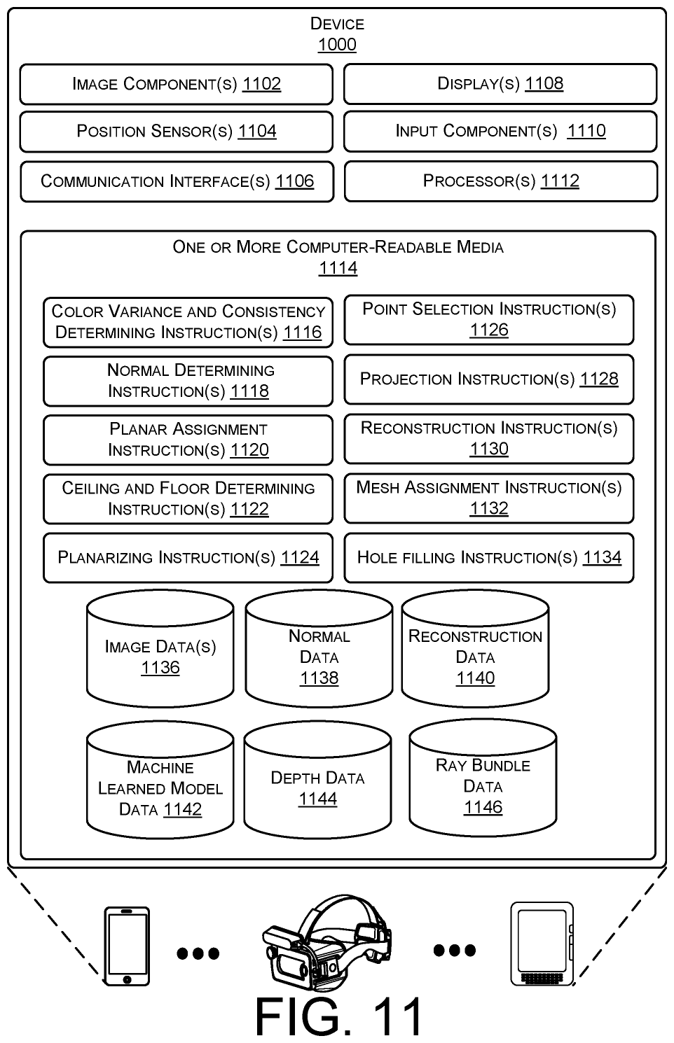

The processes discussed below with respect to FIGS. 2-10 are discussed with respect to a capture device located physically within an environment. However, it should be understood that some or all of the steps of each process may be performed on device, in the cloud, or a combination thereof. Further, it should be understood that the processes of FIGS. 2-10 may be used together or in conjunction with the examples of FIGS. 1 and 11 discussed herein.

FIG. 2 is an example flow diagram showing an illustrative process 200 for generating a three-dimensional scene reconstruction of a physical environment according to some implementations. As discussed above, in some implementations, the three-dimensional scene reconstruction may be based on and/or stored as a point having a plurality of rays or values representative of depth in various directions, such as a spherical panorama having a ray or value at each degree (or other interval).

At 202, a system may receive a plurality of frames representative of a physical environment. The frames may be captured as part of a scan or capture process of a capture or user device physically located or present within the physical environment. In some examples, the frames may be captured from a substantially single position. For example, a user may scan the environment using the capture device from a substantially stationary position. It should be understood, that during the capture process the user may adjust the position of the capture device, such that even though the user is stationary, the capture position or point may have slight variations over the capture session.

In other examples, the user may traverse or walk about the physical environment while utilizing the capture device to scan and generate image data (e.g., the frames) of the physical environment. In these examples, the frames may have different or varying capture positions or points as the user is moving while scanning the physical environment. In still other examples, the user may preform multiple stationary and/or 360-degree captures, each from a different position within the physical environment.

At 204, the system may select a three-dimensional point or position. As discussed above, the system may select the three-dimensional point as the center point of the ray bundle. For example, the system may select the capture position or point (or an average capture position) as the three-dimensional point when the capture was a spherical degree or stationary capture. In other cases, the system may select the three-dimensional point based on the frames received. For instance, the system may select the three-dimensional point to decrease an amount of hole filling to be performed during reconstruction based on the image data available and associated with the received frames.

At 206, the system may represent the plurality of frames as a sphere about the three-dimensional point. In this example, the three-dimensional point may serve as the center of the ray bundle and the image data of the plurality of frames may be stitched and/or arranged about the point to form a spherical representation of the physical environment, such as a 360-degree panorama.

At 208, the system may project the three-dimensional point into each of the frames. For example, the system may determine the intersection between the frame and the projection for each frame or other preferment intervals. For example, in some cases, the system may remove the ceiling and/or floor from the depth determination process as the ceiling and floor are substantially flat and a depth can be determined using other techniques.

At 210, the system may determine a color consistency or variation value for each projection. For example, the system may identify a patch or portion of the frame. The system may then determine a color consistency or variation value between the pixels of the frame within the patch or portion.

In other examples, the system may determine other values, such as a texture consistency or variation value, a pattern consistency or variation value, a smoothness consistency or variation value, and the like. In these examples, the system may utilize the other values in lieu of the color consistency or variation value or in addition to the color consistency or variation value in performing the process 200.

At 212, the system may rank the projections based at least in part on the color consistency or variation values. For example, rather than ranking based on a color value of each projection, which may vary depending on lighting, exposure, position, reflections, and the like, the system may rank the projections (or frames) based on the color consistency or variation value over the defined patch.

At 214, the system may select a projection for each interval based at least in part on the ranking. For example, the system may select the highest ranking projection and/or frame to use as an input to the three-dimensional scene reconstruction and depth determination discussed below at the designated or predetermined interval (e.g., each degree).

At 216, the system may determine a depth associated with selected projections based at least in part on a normal associated with the corresponding frames. In some cases, the normals may be used as a regularization constraint, making the depth values on the rays be consistent with the normals direction of the surface they intersect.

At 218, the system may generate a three-dimensional reconstruction based at least in part on the three-dimensional point and the frames and depth associated with the selected projection. The three-dimensional scene reconstruction may be represented as a point cloud (by placing a point at the correspondent depth for every ray or projection), as a mesh (for example, by connecting points at neighboring rays taking in account depth discontinuities, by Poisson surface reconstruction, or by other techniques), or other explicit or implicit surface representations, such as voxel occupation grid or truncated signed distance function.

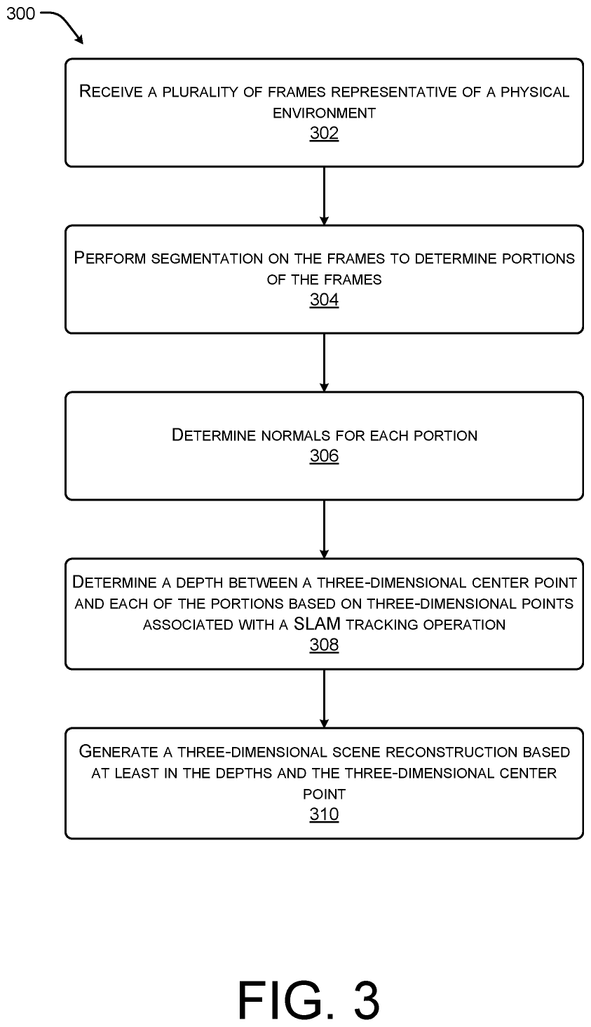

FIG. 3 is another example flow diagram showing an illustrative process 300 for generating a three-dimensional scene reconstruction of a physical environment according to some implementations. As discussed above, in some implementations, the three-dimensional scene reconstruction may be based on and/or stored as a point having a plurality of rays or values representative of depth in various directions, such as a spherical panorama having a ray or value at each degree (or other interval).

At 302, a system may receive a plurality of frames representative of a physical environment. The frames may be captured as part of a scan or capture process of a capture or user device physically located or present within the physical environment. As discussed above, the frames may be captured from a substantially single position. For example, a user may scan the environment using the capture device from a substantially stationary position. In other examples, the user may traverse or walk about the physical environment while utilizing the capture device to scan and generate image data (e.g., the frames) of the physical environment. In still other examples, the user may perform multiple stationary and/or spherical captures, each from a different position within the physical environment.

In some implementations, the system may select frames from the plurality of frames to be used as part of the process 300. For example, the system may select a subset of frames based on geometrical properties (such as frustum intersection volumes), parallax metrics, and the like. The system may then utilize the selected frames to complete the process 300 as discussed below.

At 304, the system may perform segmentation on portions of the frames. For example, the system may input the frames into a machine learned model or network and receive segmented portions of the objects, surfaces, and/or planes as an output. In some cases, the machine learned model or network may also output a class or type assigned to each of the segmented objects, surfaces, and/or planes. For example, a machine learned model or neural network may be a biologically inspired technique which passes input data (e.g., the frames or other image/sensor data) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., wall, ceiling, chair, table, floor, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

At 306, the system may determine normals for each portion. For example, the system may determine normals for each object, surface, and/or plane output by the machine learned model or neural network. The normal direction computed for every pixel or ray of input data may be the output of the machine learned model or neural network.

At 308, the system may determine a depth between a three-dimensional center point and each of the portions based on three-dimensional points associated with a SLAM tracking operation. For instance, as discussed above, the system may select a three-dimensional point as the center point of a ray bundle representing a plurality of depth values of the physical environment with respect to the center point. For example, the system may select the capture position or point (or an average capture position) as the three-dimensional center point.

The system may also receive and/or access pose data (such as six degree of freedom pose data) associated with the output of a SLAM tracking operation hosted on the capture device as the user captured the plurality of frames. The point cloud data from the SLAM tracking operation may include position and/or orientation data associated with the capture device and, as such, each of the frames are usable to determine the depth. In some examples, the depth data may also be the output of a machine learned model or network as discussed above with respect to the segmentation and classification of the portions of the frames.

At 310, the system may generate a three-dimensional scene reconstruction based at least in part on the depths and the three-dimensional center point. For example, the system may generate the three-dimensional scene reconstruction as a point (e.g., the three-dimensional center point) having a plurality of rays or values representative of depth in various directions as well the intersected frame data.

In other examples, the system may generate the three-dimensional scene reconstruction as one or more meshes. For example, the system may represent or store the three-dimensional scene reconstruction as two meshes, a foreground mesh and a background mesh. In this example, the segmented and/or classified portions (e.g., the objects, surfaces, and/or planes) may be assigned to either the foreground mesh or the background mesh based on a discontinuity in depth values when compared with adjacent portions. For instance, the portion having the smaller depth value may be assigned to the foreground while the portion having the larger depth value may be assigned to the background. In some cases, the system may determine a threshold value, such that any portion having a depth lower than or equal to the threshold value may be assigned to the foreground and/or any portion having a depth value greater than or equal to the threshold value may be assigned to the background. In still other examples, the system may assign portions to the background and foreground when a depth discontinuity between the two portions is greater than or equal to a depth continuity threshold.

In other implementation, the system may also utilize three or more meshes to represent the reconstruction, such as in larger rooms. For example, each mesh may be associated with a region or range of distances from the center point (such as a first mesh from 0-10 feet from the center point, a second region of 10-20 feet from the center point, a third mesh from 20-30 feet from the center point, and so forth and so on). In the multiple mesh configuration, the system may perform various hole filling techniques on each mesh independent of the other meshes.

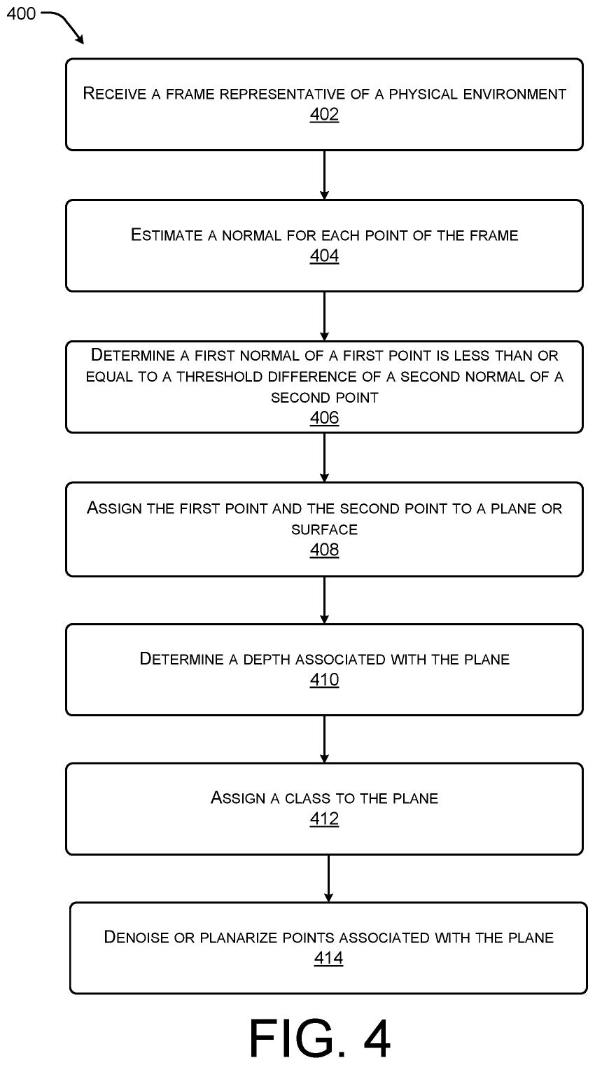

FIG. 4 is another example flow diagram showing an illustrative process 400 for generating plane of a three-dimensional scene reconstruction according to some implementations. In some cases, the system may determine planar surfaces, such as walls, ceilings, floors, sides or tops of furniture, and the like. In these cases, the system may determine a depth associated with the plane or surface as well as smooth or planarize the surface to provide a more uniform and realistic reconstruction.

At 402, a system may receive a frame representative of a physical environment. As discussed above, the frame may be captured as part of a scan or capture process of a capture or user device physically located or present within the physical environment. The frame may be captured from a substantially single position, multiple single positions, and/or as part of a roaming or moving capture session. In some cases, the frame may be a single frame of a plurality of frames captured and associated with the physical environment.

At 404, the system may estimate a normal for each point or pixel of the frame. In some case, the system may input the frame into a machine learned model or network and the machine learned model or network may assign normals to individual pixels or portions of the frame.

At 406, the system may determine a first normal of a first point or pixel is less than or equal to a threshold difference of a second normal of a second point or pixel. For example, the threshold difference may vary based on a number of pixels assigned to a nearby plane, a plane associated with either of the first point or the second point, and/or a pixel distance between the first point and the second point. In other cases, the threshold difference may be predetermined and/or associated with a semantic class (e.g., ceiling, wall, floor, table, and the like).

At 408, the system may assign the first point and the second point to a plane or surface. For example, if the normals of two nearby pixels are within a margin of error of each other, the pixels are likely to be associated with a single plane or surface and may be assigned to the same plane.

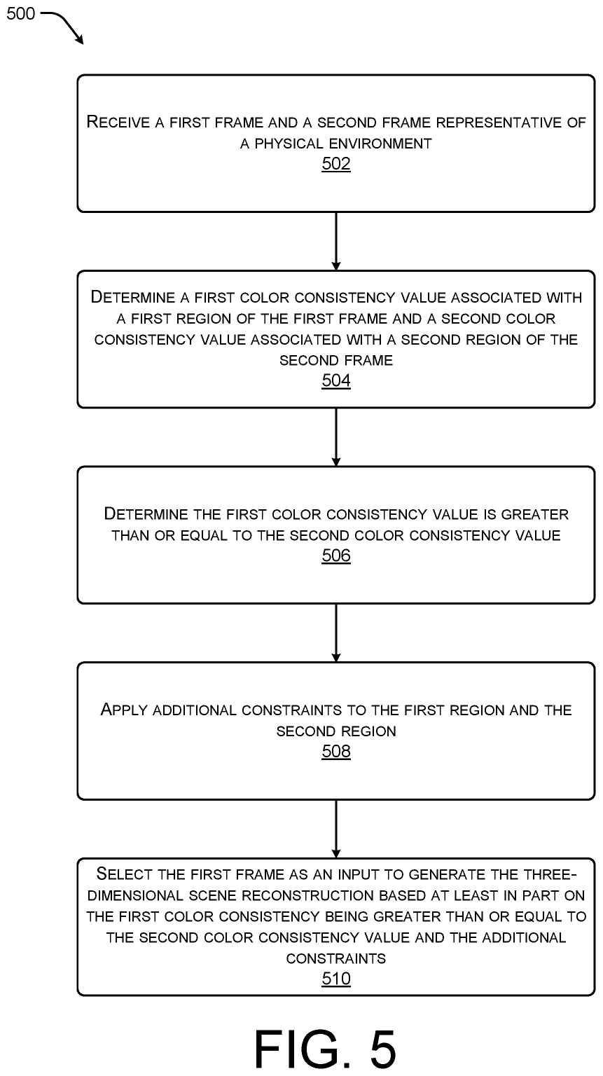

At 410, the system may determine a depth associated with the plane or surface. In one implementation, the depth of a plane can be determined by minimizing the photoconsistency error, computed integrally for the overall region. In other implementation, the depth of the plane can be determined by a RANSAC-like procedure, selecting the plane position hypothesis that is consistent with the largest number of depth values associated with the rays or panorama pixels. For example, the depth may be determined as discussed above with respect to FIGS. 1-3 and/or below with respect to FIGS. 5-10.

At 412, the system may assign or determine a class associated with the plane. For example, the system may assign the plane to be a wall, ceiling, floor, tabletop, painting, bed side, and the like. In some cases, the class may be determined using one or more machine learned models or networks, as discussed herein. In other cases, the system may assign the class based on the normals, such as a horizontal surface at ground level may be assigned to the floor class and a horizontal surface greater than a predetermined height (such as 8 feet tall) may be assigned to the ceiling class.

At 414, the system may denoise or planarize points associated with the plane. For example, the depth values associated with the points of the plane may vary due to variation associated with scanning process, the frame or image/sensor data, the machine learned models, and the like. However, as the system has determined the points belong to a plane or surface, the system may average or otherwise assign depth values to the points to cause the points to form a planar surface.

FIG. 5 is another example flow diagram showing an illustrative process 500 for generating a three-dimensional scene reconstruction of a physical environment according to some implementations. In the current example, the system may again utilize color consistency or variation values to align frames for use in generating a three-dimensional scene reconstruction.

At 502, the system may receive a first frame and a second frame representative of a physical environment. In this example, the first frame and the second frame may contain image data representative of the same portion of the physical environment and therefore may be aligned for reconstruction of the scene. For instance, the first frame and second frame may subsequent or adjacent frames captured as part of a scan or capture process of a capture or user device physically located or present within the physical environment. In some cases, the first frame and the second frame may be captured from a substantially single position, multiple single positions, and/or as part of a roaming or moving capture session.

At 504, the system may determine a first color consistency associated with a first region of the first frame and a second color consistency value associated with a second region of the second frame. The first color consistency (or variation) value may represent a change (such as a maximum color change) in color between the pixels of the first region and the second color consistency (or variation) value may represent a change (such as a maximum color change) in color between the pixels of the second region.

At 506, the system may determine the first color consistency value is greater than or equal to the second color consistency value. For example, the system may rank the frames representing the physical environment based on the color consistency value.

At 508, the system may apply one or more additional constraints to the first region and the second region. For example, the system may apply vertical constraints, horizontal constraints, Manhattan constraints or the like. In this example, the system may also determine that the first region and the second region represent the same portion of the physical environment.

At 510, the system may select the first frame as an input to generate the three-dimensional scene reconstruction based at least in part on the first color consistency being greater than or equal to the second color consistency value and the additional constraints. Alternatively, the system may select the first frame if the first frame has a lower color variation value (or higher color consistency value) over the first region (e.g., the color is more consistent).

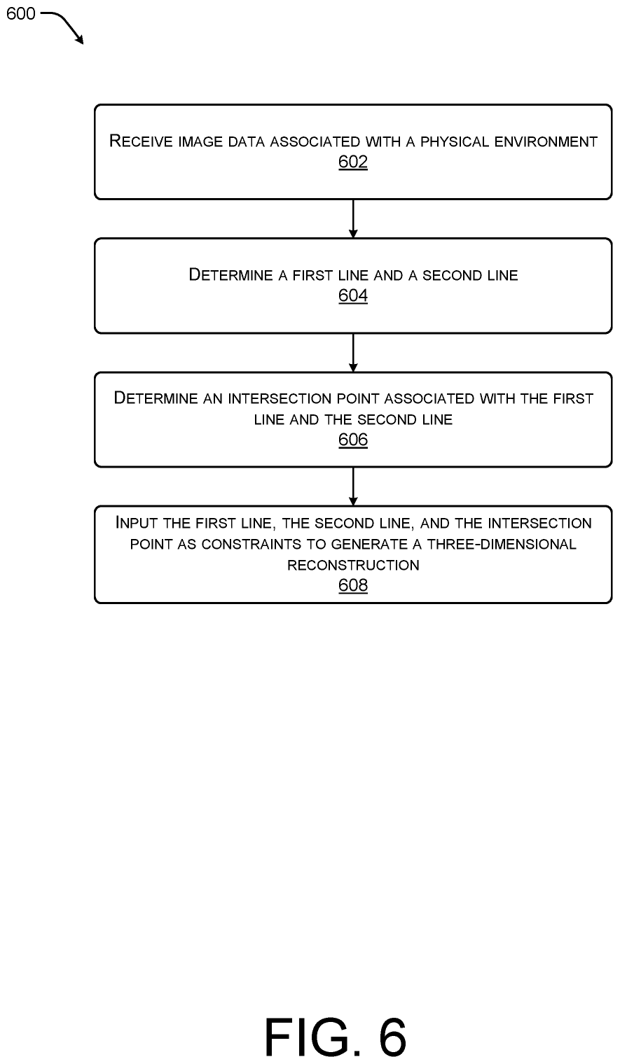

FIG. 6 is another example flow diagram showing an illustrative process 600 for generating a three-dimensional scene reconstruction of a physical environment according to some implementations. In some cases, the system may utilize additional inputs or constraints when generating the three-dimensional scene reconstruction. For instance, in the current example, the system may utilize detected lines and intersection to assist with generating the three-dimensional scene reconstruction.

At 602, the system may receive image data (such as one or more frames) associated with physical environment. As discussed above, the image data may be captured as part of a scan or capture process of a capture or user device physically located or present within the physical environment. The image data may be captured from a substantially single position, multiple single positions, and/or as part of a roaming or moving capture session. In some cases, the image data may be a single frame of a plurality of frames captured and associated with the physical environment.

At 604, the system may determine a first line and a second line associated with the image data. For example, the first line may be a joint or transition between a first wall and a ceiling and the second line may be a joint or transition between the first wall and a second wall.

At 606, the system may determine an intersection point associated with the first line and the second line. For example, the intersection may be located at a position which is not represented by the image data, such as a corner between the ceiling, first wall and second wall that was not scanned during the capture session.

At 608, the system may input the first line, the second line, and the intersection point as constraints to generate a three-dimensional reconstruction of the physical environment. For example, by determining intersection points outside of the image data, the system may more accurately or quickly generate the three-dimensional scene reconstruction and/or complete holes within the three-dimensional scene reconstruction.

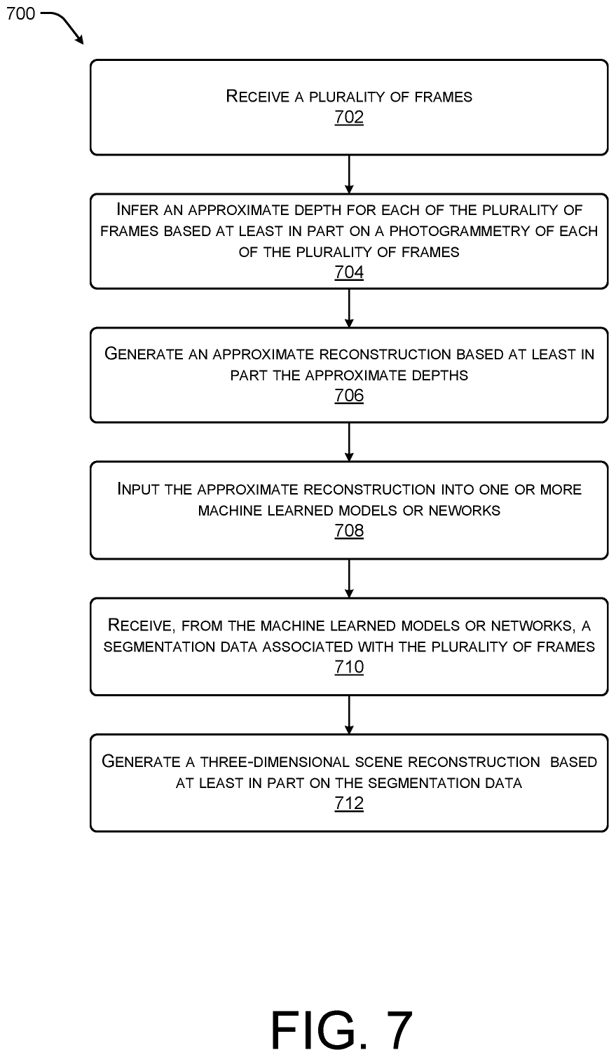

FIG. 7 is another example flow diagram showing an illustrative process 700 for generating a three-dimensional scene reconstruction of a physical environment according to some implementations. In some cases, the system may also utilize approximated or estimated depth to reduce the processing time and resources associated with generating a three-dimensional scene reconstruction.

At 702, a system may receive a frame representative of a physical environment. As discussed above, the frame may be captured as part of a scan or capture process of a capture or user device physically located or present within the physical environment. The frame may be captured from a substantially single position, multiple single positions, and/or as part of a roaming or moving capture session. In some cases, the frame may be a single frame of a plurality of frames captured and associated with the physical environment.

At 704, the system may infer an approximate depth for each of the plurality of frames based at least in part on a photogrammetry of each of the plurality of frames. For example, rather than determine the actual depth of each pixel or ray of the ray bundle, the system may approximate a depth for a region (such as a plane, surface, or object) based on photogrammetry and/or regularization techniques in a more efficient less resource intensive manner.

At 706, the system may generate an approximate reconstruction based at least in part on the approximate depths, and. For example, the system may generate an input reconstruction or intermediate reconstruction using the approximate depths. In this manner, the system may more quickly generate a reconstruction viewable by the user.

At 708, the system may input the approximate reconstruction into a machine learned model. For example, the approximate reconstruction may be used to provide the user with a more immediate model, to train a machine learned model or network and/or to utilize as additional input into, for instance, one or more machine learned model or network that may output additional data usable to generate the final three-dimensional scene reconstruction.

At 710, the system may receive, from the machine learned models or networks segmentation data associated with the plurality of frames. For example, the segmentation data may include planes, surfaces, object, and the like and in some instances, the one or more machine learned models or networks may also classify the planes, surfaces, and objects. In some cases, the output of the one or more machine learned models or networks may also include semantic information or data, such as color, depth, texture, smoothness, and the like.

At 712, the system may generate a three-dimensional scene reconstruction based at least in part on the segmentation data. For example, the segmentation data and/or the additional semantic data may be used to generate a final three-dimensional scene reconstruction as described herein.

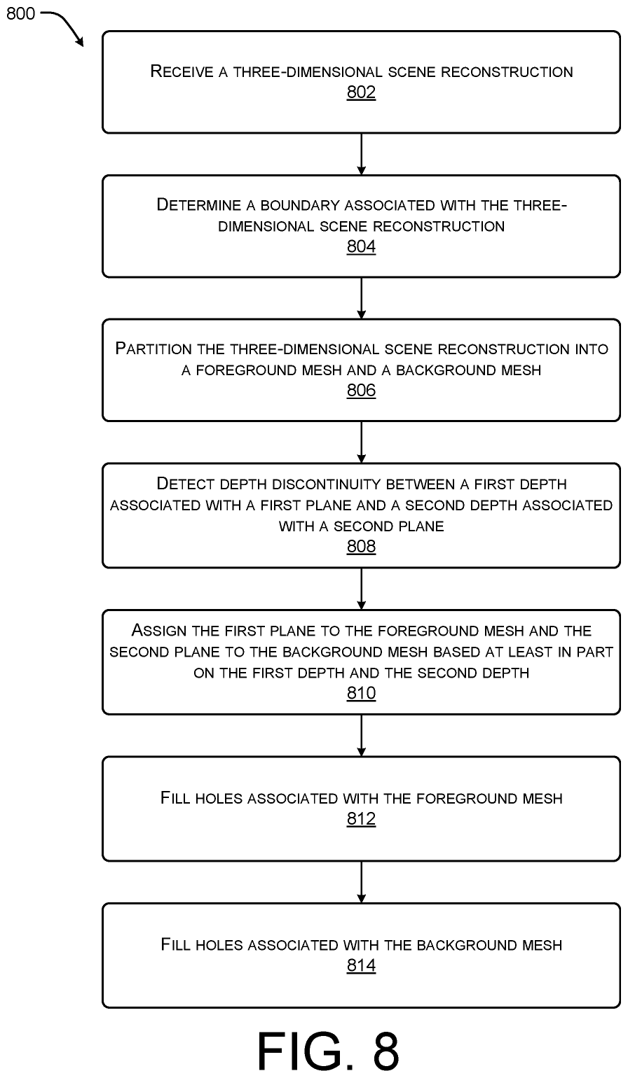

FIG. 8 is another example flow diagram showing an illustrative process 800 for generating a three-dimensional scene reconstruction of a physical environment according to some implementations. As discussed above, the three-dimensional scene reconstruction may include two or more meshes, such as a background mesh and a foreground mesh to improve the overall visual quality of the model.

At 802, the system may receive a three-dimensional scene reconstruction. For example, the three-dimensional scene reconstruction may be generated as an intermediate or temporary three-dimensional scene reconstruction as discussed above with respect to FIG. 7. In other cases, the three-dimensional scene reconstruction may be generated using the center point and ray bundles discussed above with respect to FIG. 2. In other cases, the three-dimensional scene reconstruction may be generated using machine learned models and/or networks and the like.

At 804, the system may determine a boundary associated with the three-dimensional scene reconstruction. For instance, as discussed above, the three-dimensional scene reconstruction may be formed based on a center point and a ray bundle having one or more depth values for each ray. In these cases, the system may be able to generate a photo realistic reconstruction using the image data of the frames captured during a scanning session by a user. However, as the user traverses, within the three-dimensional scene reconstruction, away from the center points (or capture point) the quality of the three-dimensional scene reconstruction may diminish. In some cases, the system may apply one or more boundaries at predetermined distances from the center point. For example, the system may apply a first boundary at which the three-dimensional scene reconstruction has a first boundary at a first threshold quality level and a second boundary at a second threshold quality level.

As the user approaches the boundary the user may be halted, redirected within the boundary, and/or warned that the quality may be reduced if the user continues. In some cases, the system may present the warning to the user at the first boundary and halt or redirect the user's movement when approaching the second boundary. In some cases, the system may utilize additional (e.g., three or more) boundaries. The system may also suggest or otherwise present to the user a recommendation to preform additional scanning or capture sessions to improve the quality outside the boundary and/or to extend the boundaries of the three-dimensional scene reconstruction. The scanning suggestion may include directions of where to position the center point during a stationary scan and/or particular objects or regions to which capturing of additional frames would improve the overall quality of the three-dimensional scene reconstruction.

At 804, the system may partition the three-dimensional scene reconstruction into a foreground mesh and a background mesh. In other cases, the system may partition the three-dimensional scene reconstruction into additional meshes (e.g., three or more meshes). In some cases, the number of meshes associated with the three-dimensional scene reconstruction may be based at least in part on a size of the three-dimensional scene reconstruction or a maximum depth to a surface from the center point of the ray bundle.

At 808, the system may detect a depth discontinuity between a first depth associated with a first plane (or object, surface, or the like) and a second depth associated with a second plane (or object, surface, or the like). For example, the first depth may be associated with a chair, table, or other object within the physical environment and the second depth may be associated with a wall. The depth discontinuity may then occur at a position where the image data transitions from representing the object to representing the wall, as the object is closer to the center point than the wall.

At 810, the system may assign the first plane to the foreground mesh and the second plane to the background mesh based at least in part on the first depth and the second depth. For example, the plane having the higher depth value (e.g., the plane further away from the center point) may be assigned to the background mesh and the plane having the lower depth value (e.g., the plane closer to the center point) may be assigned to the foreground mesh.

In some cases, the system may have to determine a line or cut between the first plane and the second plane. For instance, a human face, round furniture, or other non-uniform surface or plane may include a gradient of depths without a clear delineation between the edge of the first plane and the second plane. In these cases, the system may designate the maximum gradient as the position to form the delineation line and/or cut between the first plane and the second plane. In some cases, the system may also apply additional constraints to ensure the line or cut is cohesive and continuous to avoid situations in which a first portion of an object or plane may be assigned to the foreground mesh and a second portion of the object or plane is assigned to the background mesh.

At 812, once each of the planes have been assigned to either the foreground mesh or the background mesh, the system may fill holes associated with the foreground mesh and, at 814, the system may fill holes associated with the background mesh. For example, the system may fill holes of each of the meshes independently of the others to provide a more complete and higher quality three-dimensional scene reconstruction than conventional systems that utilize a single mesh.

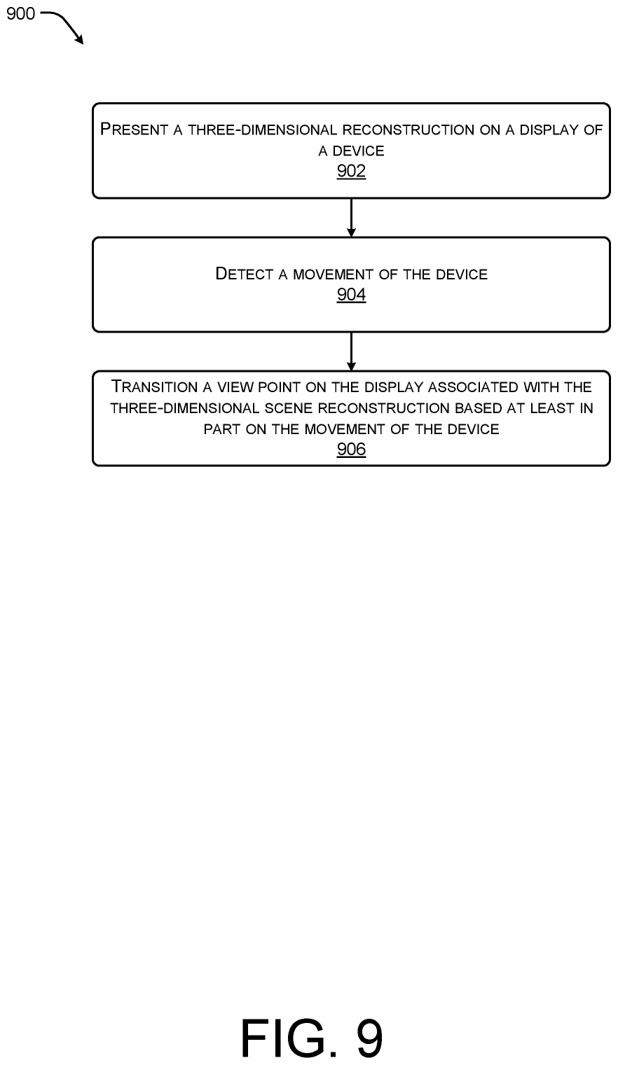

FIG. 9 is another example flow diagram showing an illustrative process 900 for presenting a three-dimensional scene reconstruction of a physical environment according to some implementations. In some cases, as a user is viewing a three-dimensional scene reconstruction, it is desirable to present the reconstruction as if the user were actually present in the physical environment.

At 902, the system may present a three-dimensional reconstruction on a display of a device. For example, the device may a be a handheld device, such as a smartphone, tablet, portable electronic device, and the like. In other examples, the device may be a headset or other wearable device. The display may be a conventional two-dimensional display and/or a three-dimensional display that provides an immersive user experience.

At 904, the system may detect a movement of the device. For instance, the device may include one or more inertial measurement unit (IMU), one or more accelerometer, one or more gyroscope, one or more magnetometer, and/or one or more pressure sensor, and the like which may provide a single indicative of a movement of the device.

At 904, the system may transition a viewpoint on the display associated with the three-dimensional scene reconstruction based at least in part on the movement of the device. For example, the system may generate two nearby or physically proximate viewpoints (such as two ray bundles with center points in proximity to each other). In this example, as the device is moved, the system may transition between the two proximate viewpoints to create an illusion or feeling of movement by the user with the three-dimensional scene reconstructions in a manner similar to a user moving their head within a physical environment. In this manner, the reconstruction may seem more real to the consuming user.

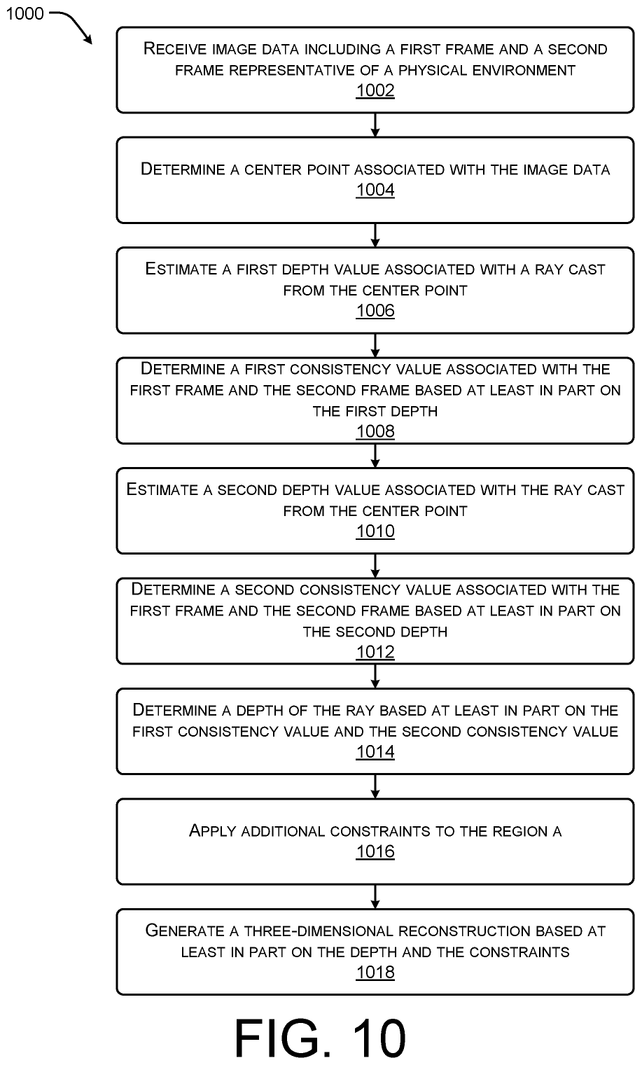

FIG. 10 is another example flow diagram showing an illustrative process 1000 for generating a three-dimensional scene reconstruction of a physical environment according to some implementations. In the current example, the system may again utilize color consistency or variation values to align frames for use in generating a three-dimensional scene reconstruction.

At 1002, the system may receive an image data including a first frame and a second frame representative of a physical environment. In this example, the first frame and the second frame may contain image data representative of the same portion of the physical environment and therefore may be aligned for reconstruction of the scene. For instance, the first frame and second frame may subsequent or adjacent frames captured as part of a scan or capture process of a capture or user device physically located or present within the physical environment. In some cases, the first frame and the second frame may be captured from a substantially single position, multiple single positions, and/or as part of a roaming or moving capture session.

At 1004, the system may determine a center point associated with the image data. For example, the system may select the capture position or point (or an average capture position) as the three-dimensional point when the capture was a spherical degree or stationary capture. In other cases, the system may select the three-dimensional point based on the frames received. For instance, the system may select the three-dimensional point to decrease an amount of hole filling to be performed during reconstruction based on the image data available and associated with the received frames.

At 1006, the system may estimate a first depth value associate with a ray cast from the center point. For example, the first depth may be an estimated depth of the ray from the center point to a surface within the physical environment. The estimate may be based on, for example, a six-degree of freedom data generated by a tracking system associated with the capture device.

At 1008, the system may determine a first consistency value associated with the first frame and the second frame based at least in part on the first depth. For example, the system may project from the first depth along the ray into each of the first frame and the second frame. The system may determine a consistency value associated with one or more visual features of the first frame and the second frame within the first projected region. As one illustrative example, the consistency value may be a color consistency between the first frame and the second frame.

At 1010, the system the system may estimate a second depth value associate with the ray cast from the center point. For example, the first depth may be an estimated depth of the ray from the center point to the surface within the physical environment. The second depth value estimate may also be based on, for example, a six-degree of freedom data generated by a tracking system associated with the capture device.

At 1012, the system may determine a second consistency value associated with the first frame and the second frame based at least in part on the second depth. For example, the system may project from the second depth along the ray into each of the first frame and the second frame. The system may determine a consistency value associated with one or more visual features of the first frame and the second frame within the seconds projected region. As one illustrative example, the consistency value may be a color consistency between the first frame and the second frame.

At 1014, the system may determine a depth of the ray based at least in part on the first consistency value and the second consistency value. For example, if the first consistency value is less than the second consistency value, the system may select the first depth as the final depth of the ray. Alternatively, if the second consistency value is less than the first consistency value, the system may select the second depth as the final depth of the ray. In this example, the system may utilize two depths and two frames, however, it should be understood, that the system may utilize any number of depths for any number of projections into any number of frames.

At 1016, the system may apply additional constraints to the region. For example, the system may apply vertical constraints, horizontal constraints, Manhattan constraints or the like. In this example, the system may also determine that the first region and the second region represent the same portion of the physical environment.

At 1018, the system may generate a three-dimensional scene reconstruction based at least in part on the final depth and the constraints. As discussed above, the three-dimensional scene reconstruction may be represented as a point cloud (by placing a point at the correspondent depth for every ray or projection), as a mesh (for example, by connecting points at neighboring rays taking in account depth discontinuities, by Poisson surface reconstruction, or by other techniques), or other explicit or implicit surface representations, such as voxel occupation grid or truncated signed distance function.

FIG. 11 is an example device associated with the three-dimensional scene reconstruction according to some implementations. As described above, the capture device 106 may be used by a user to scan or otherwise generate a three-dimensional model or scene of a physical environment. In the current example, the device 1100 may include image components 1102 for capturing visual data, such as image data, video data, depth data, color data, infrared data, or the like from a physical environment surrounding the device 1100. For example, the image components 1102 may be positioned to capture multiple images from substantially the same perspective (e.g., a position proximate to each other on the device 1100). The image components 1102 may be of various sizes and quality, for instance, the image components 1102 may include one or more wide screen cameras, three-dimensional cameras, high definition cameras, video cameras, infrared camera, depth sensors, monocular cameras, among other types of sensors. In general, the image components 1102 may each include various components and/or attributes.

In some cases, the device 1100 may include one or more position sensors 1104 to determine the orientation and motion data of the device 1100 (e.g., acceleration, angular momentum, pitch, roll, yaw, etc.). The position sensors 1104 may include one or more IMUs, one or more accelerometers, one or more gyroscopes, one or more magnetometers, and/or one or more pressure sensors, as well as other sensors. In one particular example, the position sensors 1104 may include three accelerometers placed orthogonal to each other, three rate gyroscopes placed orthogonal to each other, three magnetometers placed orthogonal to each other, and a barometric pressure sensor.

The device 1100 may also include one or more communication interfaces 1006 configured to facilitate communication between one or more networks and/or one or more cloud-based services, such as a cloud-based services 108 of FIG. 1. The communication interfaces 1106 may also facilitate communication between one or more wireless access points, a master device, and/or one or more other computing devices as part of an ad-hoc or home network system. The communication interfaces 1106 may support both wired and wireless connection to various networks, such as cellular networks, radio, WiFi networks, short-range or near-field networks (e.g., Bluetooth®), infrared signals, local area networks, wide area networks, the Internet, and so forth.

The device 1100 may also include one or more displays 1108. The displays 1108 may include a virtual environment display or a traditional two-dimensional display, such as a liquid crystal display or a light emitting diode display. The device 1100 may also include one or more input components 1110 for receiving feedback from the user. In some cases, the input components 1010 may include tactile input components, audio input components, or other natural language processing components. In one specific example, the displays 1108 and the input components 1110 may be combined into a touch enabled display.

The device 1100 may also include one or more processors 1112, such as at least one or more access components, control logic circuits, central processing units, or processors, as well as one or more computer-readable media 1114 to perform the function associated with the virtual environment. Additionally, each of the processors 1112 may itself comprise one or more processors or processing cores.

Depending on the configuration, the computer-readable media 1114 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 1112.

Several modules such as instruction, data stores, and so forth may be stored within the computer-readable media 1114 and configured to execute on the processors 1112. For example, as illustrated, the computer-readable media 1114 stores color variance and consistency determining instructions 1116, normal determining instructions 1118, planar assignment instructions 1120, ceiling and floor determining instructions 1122, planarizing instructions 1124, point selection instructions 1126, projection instructions 1128, reconstruction instructions 1130, mesh assignment instructions 1132, hole filling instructions 1134 as well as other instructions, such as operating instructions. The computer-readable media 1114 may also store data usable by the instructions 1116-1134 to perform operations. The data may include image data 1136 such as frames of a physical environment, normal data 1138, reconstruction data 1140, machine learned model data 1142, depth data 1144, and/or ray bundles 1146, as discussed above.

The color variance and consistency determining instructions 1116 may receive image data representative of a physical environment. The color variance and consistency determining instructions 1116 may then determine a color consistency or variance with respect to nearby pixels at various depths. The color variance and consistency determining instructions 1116 may then rank the frames and select the depth and/or frame having the best color consistency or variance (e.g., the smallest differences in color values may have the highest rank) for use in scene reconstruction. In other implementations, the color variance and consistency determining instructions 1116 may use a photo-consistency (e.g., for a larger area such as between portions of the frame) in lieu of or in addition to the color consistency or variance between pixels. In still other examples, the color variance and consistency determining instructions 1116 may utilize smoothness consistency or variance, texture consistency or variance, and the like to rank the frames.

The normal determining instructions 1118 may estimate normals for various points, pixels, regions or patches within the selected image data or frame, for instance, via one or more machine learned models. The system may then use the estimated normals to segment the image data into objects, planes, or surfaces and assign depth values.

The planar assignment instructions 1120 may be configured to assign pixels of the image data presentative of a physical environment to specific planes, surfaces, and the like. For example, the planar assignment instructions 1120 may detect lines, corners, and planes based on texture, color, smoothness, depth, and the like. In some cases, the planar assignment instructions 1120 may utilize user feedback such as user defined lines or planes to assist with assigning the pixels to particular planes.

The ceiling and floor determining instructions 1122 may detect ceiling and floor planes separate from other object planes or walls. For example, the ceiling and floor determining instructions 1122 may detect the ceiling and floors based on the normals indicating a horizontal plane below, for instance, a predetermined height threshold or above a predetermined height threshold. As an illustrative example, the ceiling and floor determining instructions 1122 may designate a plane as the floor if it is less than 6 inches in height and as a ceiling if it is greater than 7 feet in height.

The planarizing instructions 1124 may planarize the pixels associated with a surface, such as the ceiling and floors, as the ceiling and floors should be substantially flat or horizontal. For example, the planarizing instructions 1024 may cause the depth values of the pixels to be adjusted to generate a substantially flat surface.

The point selection instructions 1126 may be configured to select one or more points associated with image data and/or a plurality of frames to use as a center point for the ray bundle, as discussed above. In some cases, the point selection instructions 1026 may select multiple (such as two or three) proximate center points for multiple ray bundles to assist with transitioning the user between viewpoints during consumption of the three-dimensional scene reconstruction.

The projection instructions 1128 may be configured to project the point selected by the point selection instructions 1126 into the image data in order to determine a depth value associated with the projection. For example, the projection instructions 1128 may utilize the intersection between the image data and the projection to determine the depth value. In some, cases the projection instructions 1128 may generate the ray bundles by projecting a ray for each degree about the center point in a spherical manner.

The reconstruction instructions 1130 may utilize the ray bundles generated by the projection instructions 1128 to form a three-dimensional scene reconstruction. In some cases, the reconstruction instructions 1130 may utilize the image data and one or more machine learned models or networks to generate the three-dimensional scene reconstructions, as discussed above.

The mesh assignment instructions 1132 may be configured to assign planes, surfaces, and/or objects of the reconstruction to one or more meshes. For example, the system may represent or store the three-dimensional scene reconstruction as two meshes, a foreground mesh and a background mesh. In this example, the mesh assignment instructions 1132 may assign the segmented and/or classified portions (e.g., the objects, surfaces, and/or planes) to either the foreground mesh or the background mesh based on a discontinuity in depth values. For instance, the portion having the smaller depth value may be assigned to the foreground while the portion having the larger depth value may be assigned to the background. In some cases, the mesh assignment instructions 1132 may determine a threshold value, such that any portion having a depth lower than or equal to the threshold value may be assigned to the foreground and/or any portion having a depth value greater than or equal to the threshold value may be assigned to the background. In still other examples, the mesh assignment instructions 1132 may assign portions to the background and foreground when a depth discontinuity between the two portions is greater than or equal to a depth continuity threshold.

The hole filling instructions 1134 may be configured to complete or fill holes associated with each mesh generated by the mesh assignment instructions 1132. In one implementation, the holes may be filled by adding new triangles to the mesh and placing them in such positions, that some smoothness metric is minimized with a least-squares optimization procedure. The possible metrics include the discrepancy between the position of a mesh vertex and an average of its neighboring vertices, or sum of squared angles between adjacent mesh faces, and other. In this manner, the system may present a more complete or realistic reconstruction as the user traverses or otherwise moves within the scene.

While FIGS. 1-10 are shown as different implementations, it should be understood that the features of FIGS. 1-10 may be applicable to any of the implementations illustrated. For example, the processes of FIGS. 2-10 may be each be implemented by the system of FIG. 1 and/or the device as discussed in FIG. 11.

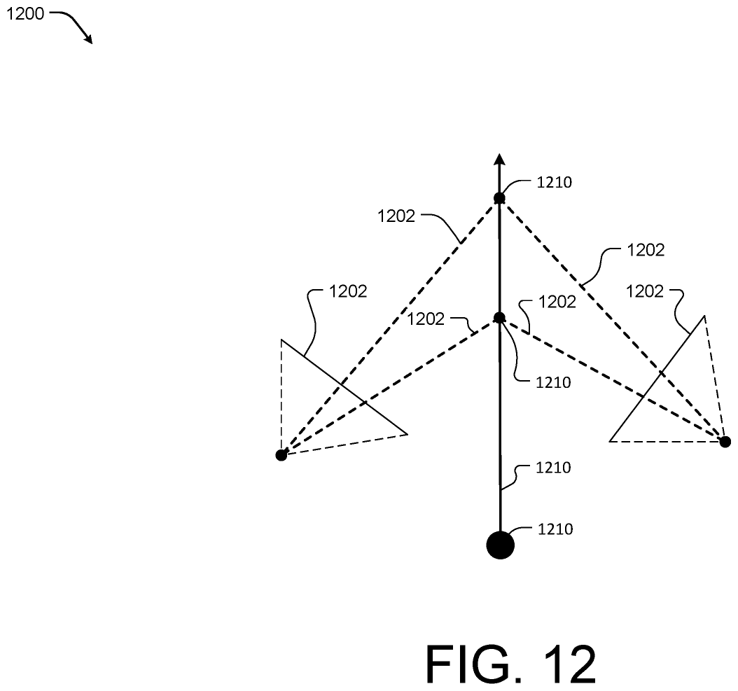

FIG. 12 is an example pictorial diagram 1200 illustrating the process 1000 of FIG. 10 according to some implementations. As discussed above, the system may select a center point 1202 that may represent the three-dimensional scene reconstruction of a physical environment as a ray bundle. In this example, a single ray 1204 is shown extending from the center point 1202. The system may then determine a depth associated with the ray 1204. For example, the system may estimate multiple depths that may be assigned as the depth value for the ray 1204.

In this example, the system may estimate a first depth 1206 and a second depth 1208 along the ray 1204. It should be understood, that any number of estimated depths may be tested and validated during the depth determination process. To determine which of the estimated depths 1206 and 1208 provide the best estimate, the system may project from the depth along the ray 1204 into two or more frames of the image data representing the physical environment. For instance, as shown, the projections 1210 and 1212 are generated from the estimated depth 1206 and the projections 1214 and 1216 are generated from the estimated depth 1208. In this example, the projections 1210 and 1214 are projected into a first frame 1218 and the projections 1212 and 1216 are projected into a second frame 1220.

The system may then determine a first consistency value between the regions of the frames 1218 and 1220 defined by the projection 1210 and 1212 associated with the first depth 1206 and a second consistency value between the regions of the frames 1218 and 1220 defined by the projection 1214 and 1216 associated with the second depth 1208. The system may then determine which depth has a higher consistency value (e.g., the measured visual metric is more consistent and has a lower visual difference) and select that depth, either 1206 or 1208 in this example, as the assigned depth for the ray 1204. It should be understood, that the system may apply the process, discussed herein, to each ray of the center point 1202 in a 360 degree manner at a predestined interval to represent the three-dimensional scene.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A device comprising:
a display;
one or more image components for capturing image data associated with a physical environment surrounding a user;
one or more processors; and
non-transitory computer-readable media storing computer-executable instructions, which when executed by the one or more processors cause the one or more processors to perform operations comprising:
receiving plurality of frames associated with the physical environment from the one or more image components;
selecting a center point associated with the plurality of frames;
casting a ray from the center point;
estimating a first position and a second position along the ray;
projecting the first position into the plurality of frames to determine a first consistency value;
projecting the second position into the plurality of frames to determine a second consistency value;
determining a depth value associated with the ray based at least in part on the first consistency value and the second consistency value; and
generating a three-dimensional scene reconstruction based at least in part on the depth value.

2. The device as recited in claim 1, further comprising one or more position sensors for capturing orientation and motion data associated with the device and wherein generating the three-dimensional scene reconstruction is based at least in part on the orientation and motion data.

3. The device as recited in claim 1, wherein:
the center point is a first center point;
generating the three-dimensional scene reconstruction further comprises generating a first viewpoint of the three-dimensional scene reconstruction, the first viewpoint associated with the first center point; and
wherein the operations further comprise:
selecting a second center point, the second center point within a threshold distance of the first center point;
casting a second ray from the second center point;
estimating a first position and a second position along the second ray;
projecting the first position of the second ray into the plurality of frames to determine a third consistency value;
projecting the second position of the second ray into the plurality of frames to determine a fourth consistency value;
determining a depth value associated with the second ray based at least in part on the third consistency value and the fourth consistency value; and
generating a second viewpoint of the three-dimensional scene reconstruction and associated with the second center point based at least in part on the second depth value.

4. The device as recited in claim 1, wherein the operations further comprise:
defining a first region within the plurality of frames;
defining a second region within the plurality of frames;
determining the first region has a second depth value greater than a third depth value associated with the second region;
assigning, at least in part in response to determining the second depth value is greater than the third depth, the first region to a background mesh; and
assigning, at least in part in response to determining the second depth value is greater than the third depth, the second region to a foreground mesh.

5. The device as recited in claim 4, wherein the operations further comprise defining a boundary between the first region and the second region based at last in part on a discontinuity in a depth associated with the first region and the second region.

6. The device as recited in claim 1, wherein the operations further comprise determining a boundary of a navigable region of the three-dimensional scene reconstruction based at least in part on the center point.

7. The device as recited in claim 1, wherein the ray is a first ray, the depth value is a first depth value, and the operations further comprising:
casting a second ray from the center point, the second ray extending sharing a trajectory with the first ray;
estimating a third position and a fourth position along the second ray;
projecting the third position into the plurality of frames to determine a third consistency value;
projecting the fourth position into the plurality of frames to determine a fourth consistency value; and
determining a second depth value associated with the second ray based at least in part on the third consistency value and the fourth consistency value, the second depth value different than the first depth value.

8. The device as recited in claim 1, wherein the first consistency value includes associated with one or more of the following:
a color consistency;
a texture consistency;
a normal consistency;
a gradient consistency; or
a feature descriptor consistency.

9. The device as recited in claim 1, wherein the depth value is a first depth value and the operations further comprising:
estimating a third position and a fourth position along the ray;
projecting the third position into the plurality of frames to determine a third consistency value;
projecting the fourth position into the plurality of frames to determine a fourth consistency value; and
determining a second depth value associated with the ray based at least in part on the third consistency value and the fourth consistency value, the second depth value different than the first depth value.

10. The device as recited in claim 1, wherein:
determining the depth value for a first individual projection further comprise applying additional constraints; and
the additional constraint includes one or more of the following:
a Manhattan world constraint;
a vertical constraint;
a habitational constraint;
a perpendicular;
a parallel;
a normal constraint;
a smoothness constraint;
a planarity constraint; or
a semantic-based constraint.

11. The device as recited in claim 1, wherein the operations further comprise segmenting and classifying data associated with the plurality of frames.

12. A method comprising:
determining a point associated with image data representing a three-dimensional physical environment;
determining an estimated depth associated with a ray cast from the point;
projecting the estimated depth into a first frame of the image data to determine a first value;
projecting the estimated depth into a second frame of the image data to determine a second value;
determining a final depth value of the ray based at least in part on the first value and the second value; and
generating a three-dimensional scene reconstruction of the physical environment based at least in part on the final depth.

13. The method as recited in claim 12, wherein the point includes multiple associated rays, a position of individual rays are at predetermined interval from the at least one other ray.

14. The method as recited in claim 12, wherein determining the final depth value of the ray based at least in part on a visual consistency value associated with the first value and the second value.

15. The method as recited in claim 12, further comprising:
determining the first surface depth is associated with a first surface and a second surface depth is associated with a second surface;
determining a value representative of a difference between the first surface depth value and the second surface depth; and
assigning a first surface to a first mesh and a second surface to a second mesh based at least in part on the value.

16. The method as recited in claim 15, further comprising:
filling holes associated with the first mesh independently from operations associated with the second mesh.

17. One or more non-transitory computer-readable media storing computer-executable instructions, which when executed by one or more processors cause the one or more processors to perform operations comprising:
receiving a plurality of frames representative of a physical environment;
selecting a point, the point related to the plurality of frames;
generating a ray, for a plurality of degrees of the point with respect to the point;
determining a depth value for individual rays; and
storing the depth values as a ray bundle associated with the physical environment.

18. The device as recited in claim 17, further comprising generating a three-dimensional scene reconstruction based at least in part on the ray bundle.

19. The device as recited in claim 17, wherein determining the depth value for a first individual ray is based at least in part on a normal associated with a region of an individual frame of the plurality of frames, the individual frame associated with the first individual ray.

20. The device as recited in claim 17, further comprising defining a boundary between a first surface and a second surface based at least in part on a discontinuity in a depth associated with pixels of the first surface and the second surface.
